(19) United States
(12) Patent Application Publication
(10) Pub. No.: US 2006/0137472 A1
(43) Pub. Date: Jun. 29, 2006

(54) Torque measuring apparatus, torque monitoring system, and torque monitoring method

(76) Inventors: Ki Dong Kim, Incheon-city (KR); Kyoung Pyo Ha, Hwaseong-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,765

(22) Filed: Dec. 15, 2005

(30) Foreign Application Priority Data
Dec. 23, 2004 (KR) 10-2004-0111257

(51) Int. Cl. G01L 3/10

(52) U.S. Cl. 73/862.328

(57) ABSTRACT

A torque measuring apparatus and torque monitoring system according to the exemplary embodiment of the present invention measures torque of a rotating shaft and is capable of synchronously measuring torque of a plurality of objects.

### CROSS-REFERENCE TO RELATED APPLICATION

This application claims priority to and the benefit from Korean Patent Application No. 10-2004-0111257 filed in the Korean Intellectual Property Office on Dec. 23, 2004, the entire contents of which are incorporated herein by reference.

### BACKGROUND OF THE INVENTION

(a) Field of the Invention

The present invention relates to a torque measuring apparatus and a torque monitoring system. More particularly, the torque measuring apparatus and torque monitoring system utilizes a piezoelectric sensor and Bluetooth technology.

(b) Description of the Related Art

Torque is, for example, a force acting on a rotating shaft for power transmission. Torque is also called a torsional moment. A rotating body acting as an element of various machines (e.g. as a rotating shaft of a vehicle or a shaft of a machine tool) for power transmission receives a load torque. Therefore, it is important to measure accurate torque for efficient power transmission of the rotating body.

Traditionally, torque is measured by a strain gauge sensor. The strain gauge sensor is excellent for measuring static torque, but may not be available for measuring torque of the rotating body because the torque of the rotating body dynamically changes.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a torque measuring apparatus and system for dynamic measuring of rotating shaft torque and synchronous measuring when there are provided a plurality of objects to be measured.

In some embodiments a torque measuring apparatus measures torque delivered from a driving shaft to a driving shaft. The apparatus includes a rotating body, a sensor unit, and a Bluetooth unit. One end of the rotating body is fixedly connected to the driving shaft and the other end of the rotating shaft is fixedly connected to the driven shaft. The sensor unit outputs a torque signal corresponding to the torque delivered from the driving shaft. The Bluetooth unit transmits the torque signal output from the sensor unit through Bluetooth communication.

The sensor unit includes a piezoelectric sensor, an encoder unit, a signal processor, and a power supply unit. The piezoelectric sensor is disposed between the driving shaft and the rotating body or between the rotating body and the driven shaft, and outputs an electric signal corresponding to the torque delivered from the driving shaft. The encoder unit outputs the corresponding control signal when the rotating body rotates a predetermined degree. The signal processor outputs a torque signal corresponding to torque delivered from the driving shaft when the rotating body rotates the predetermined degree based on the electric signal of the piezoelectric sensor and the control signal of the encoder unit. The power supply unit supplies a power for driving the signal processor.

The power supply unit includes a power source, a stator, and a rotor. The stator is electrically connected to the stator, and fixedly disposed around an outside of the rotating body. The rotor is mounted on the rotating body for integral rotation with the rotating body inside the stator, and electrically connected to the sensor unit for supplying electricity to the sensor unit.

The encoder unit includes an infrared light emitting portion, a first plate, a second plate, an infrared light receiving portion, and a circuit portion. The infrared light emitting portion is disposed to the stator. The first plate is disposed to the infrared light emitting portion and has a plurality of first slits radially provided at angular intervals of a first predetermined angle. Infrared emitted from the infrared light emitting portion passes through the plurality of first slits. The second plate is fixedly mounted on the rotating body to face the first plate, and has a plurality of second slits radially provided at angular intervals of a second predetermined angle. The infrared passed through the plurality of first slits passes through the plurality of second slits. The infrared light receiving portion receives the infrared passed through the second plate. The circuit portion outputs the control signal when the infrared light receiving portion receives the infrared.

The Bluetooth unit includes a Bluetooth transmitter and a Bluetooth receiver. The Bluetooth transmitter receives the torque signal output from the sensor unit and transmits the received torque signal through Bluetooth communication. The Bluetooth receiver receives the torque signal transmitted from the Bluetooth transmitter.

Another torque monitoring system monitoring torque delivered from a driving shaft to a driven shaft according to an exemplary embodiment of the present invention the torque monitoring system including a rotating body, a sensor unit, a Bluetooth unit, and a monitoring unit. The rotating body has one end fixedly connected to the driving shaft and the other end fixedly connected to the driven shaft. The sensor unit output a torque signal corresponding to torque delivered from the driving shaft. The Bluetooth unit includes a Bluetooth transmitter receiving the torque signal output from the sensor unit and transmitting the received torque signal through Bluetooth communication, and a Bluetooth receiver receiving the torque signal transmitted from the Bluetooth transmitter. The monitoring unit is connected to the Bluetooth receiver and monitors the received torque signal.

The rotating body, the sensor unit, and the bluetooth transmitter are plurally provided, respectively, and each of the respective elements is disposed to a plurality of torque measure locations of one object to be measured or respectively disposed to a plurality of torque measure locations of a plurality of objects to be measured.

The sensor unit includes a piezoelectric sensor, an encoder unit, a signal processor, and a power supply unit. The piezoelectric sensor is disposed between the driving shaft and the rotating body or between the rotating body and the driven shaft, and outputs an electric signal corresponding to the torque delivered from the driving shaft. The encoder unit outputs the corresponding control signal when the rotating body rotates a predetermined angle. The signal processor outputs a torque signal corresponding to torque delivered from the driving shaft when the rotating body rotates the predetermined angle based on the electric signal of the piezoelectric sensor and the control signal of the encoder unit. The power supply unit supplies a power for driving the signal processor.

Another exemplary torque monitoring method for monitoring torque delivered from a driving shaft to a driven shaft according to an embodiment of the present invention, the method including measuring torque delivered from the driving shaft to the driven shaft at predetermined period and generating the corresponding electric signal, generating a torque signal based on the electric signal, wirelessly transmitting the torque signal through Bluetooth communication, and monitoring the torque signal received through the Bluetooth communication.

### BRIEF DESCRIPTION OF THE DRAWINGS

FIG. 1 is a block diagram of a torque measuring apparatus and torque monitoring system according to an exemplary embodiment of the present invention;

FIG. 2 shows a rotating body of a torque measuring apparatus and torque monitoring system according to an exemplary embodiment of the present invention;

FIG. 3 shows a torque measuring apparatus and torque monitoring system mounted on a valve train system according to an exemplary embodiment of the present invention;

FIG. 4 shows a piezoelectric sensor of a torque measuring apparatus and torque monitoring system according to an exemplary embodiment of the present invention;

FIG. 5 shows a power unit of a torque measuring apparatus and torque monitoring system according to an exemplary embodiment of the present invention;

FIG. 6 shows an encoder unit of a torque measuring apparatus and torque monitoring system according to an exemplary embodiment of the present invention; and

FIG. 7 is a flowchart of a torque measuring method according to an exemplary embodiment of the present invention.

### DETAILED DESCRIPTION OF THE EMBODIMENTS

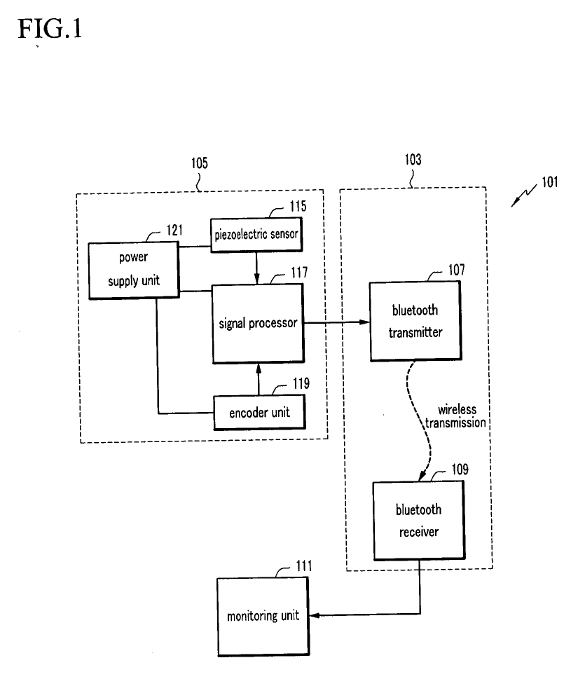

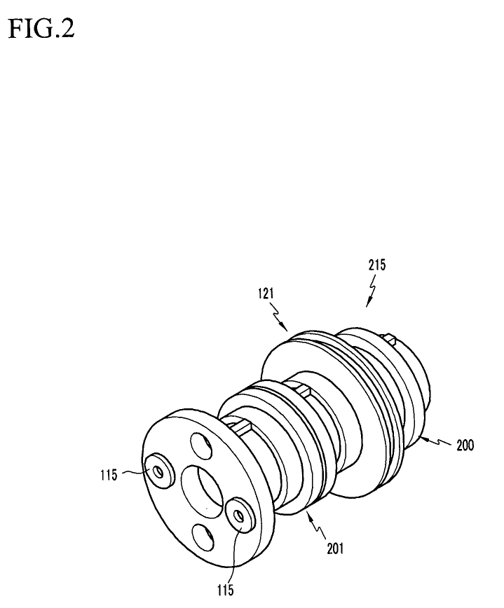

Referring to FIGS. 1 to 3, a torque measuring apparatus 101 is disposed between a driving shaft 305 and a driven shaft 307, and measures torque delivered to the driven shaft 307 from the driving shaft 305. The torque measuring apparatus 101 includes a rotating body 215, a sensor unit 105, and a Bluetooth unit 103. One end of the rotating body 214 is fixedly connected to the driving shaft 205 and the other end is fixedly connected to the driven shaft 307. The sensor unit 105 outputs a torque signal corresponding to the torque delivered from the driving shaft 305, and the Bluetooth unit 103 transmits/receives the torque output from the sensor unit 105 through Bluetooth communication.

The torque monitoring system according to the exemplary embodiment of the present invention includes a torque measuring apparatus 101 and a monitoring unit 111. The monitoring unit 111 may be provided as an apparatus capable of receiving a signal from the Bluetooth unit 103 and monitoring the signal. For example, the monitoring unit 111 may be a computer, a mobile communication terminal, a Personal Digital Assistant (PDA), or the like.

The torque is measured by the sensor unit 105 and delivered to the monitoring unit 11 through the Bluetooth unit 103. The monitoring unit 11 receives, stores, and analyzes the torque signal. The sensor unit 105 includes a piezoelectric sensor 115, an encoder unit 119, a signal processor 117, and a power supply unit 121. The piezoelectric sensor 115 is provided between the driving shaft 305 and the rotating body 215, and outputs an electric signal corresponding to the torque delivered from the driving shaft 305. The piezoelectric sensor 115 may be provided between the rotating body 215 and the driven shaft 307. The encoder unit 119 is expected to output the corresponding signal whenever the rotating body 215 rotates a predetermined degree.

Based on the electric signal of the piezoelectric sensor 115 and the control signal of the encoder unit 119, the signal processor 117 generates a torque signal corresponding to a torque delivered from the driving shaft 305 whenever the rotating body 215 rotates the predetermined degree.

The power supply unit 121 supplies a power for driving the signal processor 117. The rotating body 215 includes a piezoelectric sensor 115, a power supply unit 121, and connector rings 200 and 201 according to the exemplary embodiment of the present invention. A plate 300 is disposed to the connector ring 201 located closer to the piezoelectric sensor 115, and the encoder unit 119 is disposed to the connector ring 200 located farther to the piezoelectric sensor 115 such that the connector rings 200 and 201 rotates together with the rotating body 215. The signal processor 117 and a Bluetooth transmitter 107 are mounted on the plate 300.

The plate 300 provided with the signal processor 117 and the Bluetooth transmitter 107 integrally rotates with the rotating body 215, and accordingly torque can be measured without any influence even though the driving shaft 305 and the driving shaft 307 continually rotate. The rotating body 215 is disposed between the driving shaft 305 and the driven shaft 307 and measures torque of the valve train system 309. In more detail, the piezoelectric sensor 115 of the sensor unit 105 provided to the rotating body 215 measures the torque of the valve train system 309.

A motor 301 rotates the driving shaft 305 and the driving shaft 307 of the valve train system 309. Rotation of the driven shaft 307 of the valve train system 309 by the motor 301 causes torque of the driven shaft 307, and the torque measuring apparatus 101 measures the torque. In general, an amount of torque is constant at any location of the driving shaft 305 and the driven shaft 307, and accordingly the piezoelectric sensor 115 may be disposed to any location of the driving shaft 305 and the driven shaft 307.

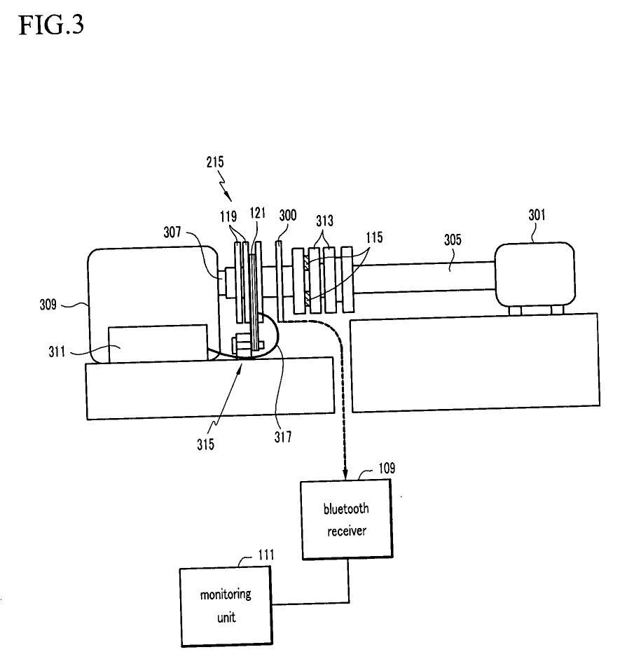

A coupling 313 is disposed between the rotating body 215 and the driving shaft 305 and connects the driving shaft 305 and the rotating body 215 provided with the sensor unit 105. Referring to FIG. 3, the piezoelectric sensor 115 is disposed between the driving shaft 305 and the rotating body 215.

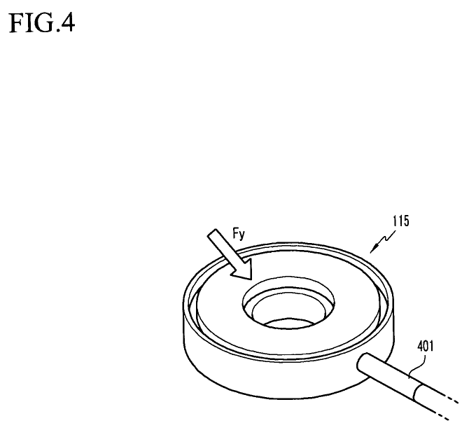

FIG. 4 shows the piezoelectric sensor 115 of the torque measuring apparatus and torque monitoring system according to the exemplary embodiment of the present invention. Referring to FIG. 4, charges in the piezoelectric sensor 115 are polarized when torque acts on the piezoelectric sensor 115 in Fy direction, and such a polarization phenomenon is transmitted to the signal processor 117 through a conductor 401.

A piezoelectric shear force sensor is provided as the piezoelectric sensor 115 according to the exemplary embodiment of the present invention, and it is not restrictive. The piezoelectric sensor 115 is well known to those skilled in the art, and thus further description will not be provided. An electric signal of the torque measured by the piezoelectric sensor 115 is input to the signal processor 117. In addition, the encoder unit 119 outputs a control signal to the signal processor 117 in order to control the signal processor 117 receives signals from the piezoelectric sensor 115 at a predetermined interval. Therefore, the signal processor 117 receives the electric signal from the piezoelectric sensor 115 at the predetermined interval. As described above, torque measure is more accurate and constant that that of the prior art as a signal is input at a predetermined interval according to an exemplary embodiment of the present invention.

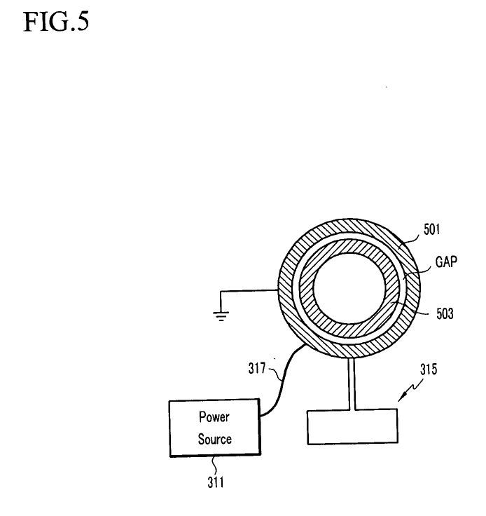

FIG. 5 shows a power supply unit of the torque measuring apparatus and torque monitoring system according to the exemplary embodiment of the present invention. The power supply unit 121 includes a power source 311, a stator 501, and a rotor 503, and supplies a power to the sensor unit 105. Referring to FIG. 3 and FIG. 5, the power source 311 is connected to the stator 501. The rotor 503 is fixed to the rotating body 215 so that it integrally rotates with the rotating body 215, and electrically connected to the sensor unit 105 for electric power supply. The stator 501 is fixedly disposed to an outer side of the rotor 503 by a supporting unit 315 and a predetermined gap is provided between the rotor 503 and the stator 501 such that the stator 501 does not contact to the stator 503. The gap is set to be 1 mm according to the exemplary embodiment of the present invention, and it is not restrictive.

When an alternating voltage and current is supplied to the stator 501 from the power source 311 through the conductor 317, a magnetic flux is induced into the rotor 503 through the gap such that a voltage and a current are induced to a coil provided inside the rotor 503. The current and voltage generated from the rotor 503 are supplied to the sensor unit 105 for driving the sensor unit 105. As described above, the rotor 503 of the power supply unit 121 supplies a power to the signal processor 117 of the plate 300 fixed to the rotating body 215 while integrally rotating with the rotating body 215. In addition, a conductor for power transmission between the stator 501 and the rotor 503 is not required since they do not contact to each other. Therefore, driving power transmission becomes more efficient than using a conduct.

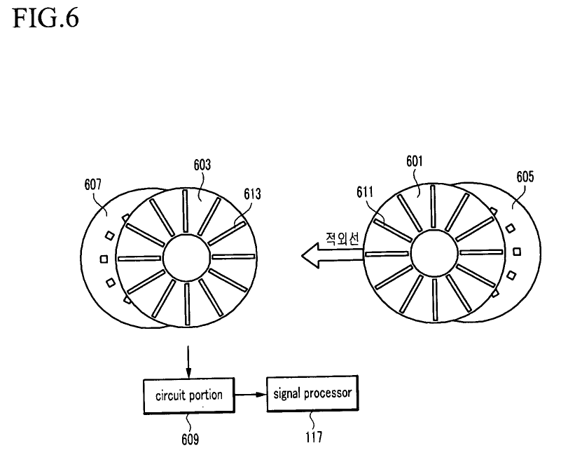

FIG. 6 shows an encoder unit 119 of the torque measuring apparatus and torque monitoring system according to the exemplary embodiment of the present invention. The encoder unit 119 includes a light emitting portion 605, a first plate 601, a second plate 603, a light receiving portion 607, and a circuit portion 609. The light emitting portion 605 is disposed to the stator 501. Thus, the light emitting portion 605 is fixed to the stator 510, and emits infrared. The emitted infrared passes through the first plate 601 having a plurality of first slits 611 radially provided at angular intervals of a first predetermined angle. The first predetermined angle is preferably set to be about 24° according to an exemplary embodiment of the present invention, however, the first predetermined angle can be between about 20 degrees and about 30 degrees.

The second plate 603 is fixedly mounted on the rotating body 215, facing the first plate 601. A plurality of second slits 613 are radially provided to the second plate 603 at angular intervals of a second predetermined angle, and the infrared passed through the first slit 611 passes through the second slits 613. The second plate 603 and the light receiving portion 607 integrally rotate with the rotating body 215 because they are disposed on the rotating body 215. The second predetermined angle is preferred to be about 22.5° according to an exemplary embodiment of the present invention, however, the second predetermined angle can be between about 20 degrees and about 30 degrees. Therefore, the infrared emitted from the light emitting portion 605 passes through the first slits 611 and reaches the second plate 603.

The light emitting portion 605 and the first plate 601 are fixed to the stator 501, the light receiving portion 607 the second plate 603 are fixed to the rotating body 215 and integrally rotate with the rotating body 215. Therefore, the infrared emitted from the light emitting portion 605 passes through the first slits 611 of the first plate 601 the first slit 611 and the second slits 613 of the second plate 603 the second slit 613 and then reaches the light receiving portion 607.

The first predetermined angle is set to be about 24° according to an exemplary embodiment of the present invention, and accordingly a total number of first slits 611 formed to the first plate 601 is fifteen. In addition, the second predetermined angle is set to be about 22.5°, and accordingly, the infrared is received at the light receiving portion when the second plate 603 rotates about 1.5°.

When the light receiving portion 607 receives the infrared, the circuit portion 609 connected to the light receiving portion 607 transmits a control signal to the signal processor 117. The signal processor 117 receives an electric signal from the piezoelectric sensor 115 based on the control signal of the encoder unit 119. Based on the electric signal from the piezoelectric sensor 115 and the control signal from the circuit portion 609 of the encoder unit 119, the signal processor 117 generates and outputs a torque signal.

The signal processor 117 also acts as a charge amplifier that amplifies an electric signal and analog to digital converter (ADC) converting an analogue signal to a digital signal. Therefore, the signal processor 117 amplifies the signal from the piezoelectric sensor 115, converts the amplified signal to a digital signal, and outputs the digital signal as a torque signal.

The Bluetooth unit 103 of the torque measuring apparatus 101 includes a Bluetooth transmitter 107 and a Bluetooth receiver 109. Referring to FIG. 1 and FIG. 3, the Bluetooth transmitter 107 receives the torque signal output from the sensor unit 105 and outputs the received torque signal to the Bluetooth receiver 109 through Bluetooth communication. The Bluetooth receiver 109 receives the torque signal from the Bluetooth transmitter 107 and delivers the received toque signal to the monitoring unit 111. In addition, the Bluetooth transmitter 107 and the signal processor 117 are disposed to the plate 300 that is mounted on the connector ring 210.

The Bluetooth receiver 109 is externally disposed to a location of the torque measuring apparatus 101, where wireless communication is available. In general, an effective range of Blue communication is within 10 m to 100 m. Therefore, it is preferred to dispose the Bluetooth receiver 109 with the effective range and it is not restrictive. A Bluetooth unit adapts a master-slave connection and several (e.g. seven slaves) may be connected to one master. The Bluetooth receiver 107 acting as a master is connected to the Blue transmitter 107 according to the exemplary embodiment of the present invention. Therefore, the torque measuring apparatus 101 may synchronously measure torque from a plurality of locations or of a plurality of apparatus. The Bluetooth communication is well known a person of an ordinary skill in the art, and thus a further description will not be provided.

The torque monitoring system includes the torque measuring apparatus 101 and further includes the monitoring unit 111 monitoring a torque signal according to the exemplary embodiment of the present invention. When there are provided a plurality of rotating bodies 215, a plurality of sensor units 105, and a plurality of Bluetooth transmitters 107 of the Bluetooth unit 103, each of the respective elements is provided to a plurality of torque measure locations of one object to be measure, or respectively provided to a plurality of torque measure locations of a plurality of objects to be measured so that torque can be synchronously measured.

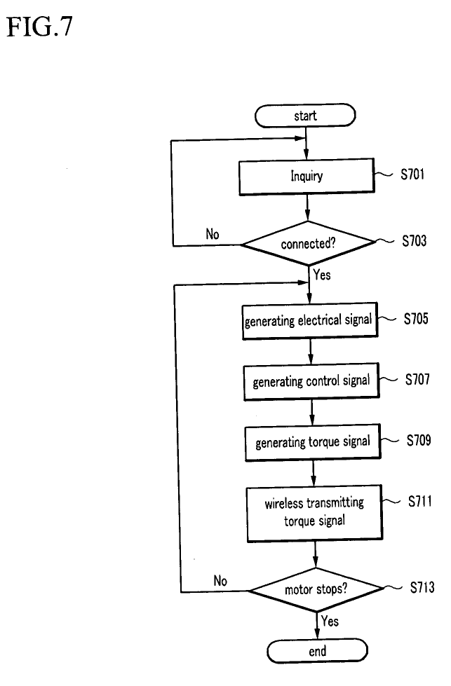

FIG. 7 is a flowchart of a torque measuring method according to the exemplary embodiment of the present invention. A torque measuring method using the torque monitoring system will now be described. When the monitoring system is operated and a motor starts rotating, the Bluetooth receiver 109 of the Bluetooth unit 103 inquires the Bluetooth transmitter 107 in step S701.

In step S703, Bluetooth connection between the Bluetooth receiver 109 and the Bluetooth transmitter 107 is checked after the inquiry process of step S701. If establishment of the Bluetooth connection between the Bluetooth receiver 109 and the Bluetooth transmitter 107 is checked in step S703, torque delivered from the driving shaft 305 to the driven shaft 306 is measured at a predetermined time interval and the corresponding electric signal is generated in step S705. In addition, if the Bluetooth connection between the Bluetooth receiver 107 and the Bluetooth transmitter 107 is not established, returns to step S701.

When the electric signal is generated by the piezoelectric sensor 115 of the sensor unit 105 in step S705, the encoder unit 119 generates a control signal to control the electric signal to be captured at a predetermined in step S707. Based on the control signal and the electric signal generated in steps S705 and S707, the signal processor 117 of the sensor unit 105 generates a torque signal in step S709. The torque signal generated in step S709 is wirelessly transmitted to the Bluetooth receiver 109 by the Bluetooth transmitter 107 in step S711.

The signal processor 117 stores a predetermined number of torque signals, and wirelessly transmits the stored torque signals through the Bluetooth transmitter 107. A total number of torque signals stored in the signal processor 117 and then transmitted is set to be 1800 according to the exemplarily embodiment of the present invention and it is not restrictive. When the torque signal is transmitted, the signal processor 117 determines whether the motor 301 for measuring torque stops rotating in step S713. If the motor 310 stops rotating in step S173, the measuring process is finished. Otherwise, the measuring process returns to step S705 and continues the measuring process.

The signal processor 117 may be realized by at least one microprocessor operated by a predetermined program, and the predetermined program can be programmed to include a set of instructions to perform steps in a method according to an exemplary embodiment of the present invention, which will later be described in more detail. According to the exemplary embodiment of the present invention, a torque measuring apparatus is mounted on a rotating shaft formed in a rotating body shape, and thus, it is possible to measure torque of the rotating shaft. In addition, according to the exemplary embodiment of the present invention, the torque measuring apparatus and torque measure system include the Bluetooth unit, and accordingly, torque of a plurality of objects can be synchronously measured.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1-8. (canceled)

9. A torque measuring apparatus, comprising:
a rotating body having one end fixedly connected to a driving shaft and a second end fixedly connected to a driven shaft;
a sensor unit outputting a torque signal corresponding to a torque delivered from the driving shaft; and
a Bluetooth unit transmitting the torque signal output from the sensor unit through Bluetooth communication.

10. The torque measuring apparatus of claim 9, wherein the sensor unit comprises:
a piezoelectric sensor disposed between the driving shaft and the rotating body or between the rotating body and the driven shaft, and configured to output an electric signal corresponding to the torque delivered from the driving shaft;
an encoder unit configured to output the corresponding control signal when the rotating body rotates a predetermined degree;
a signal processor configured to output a torque signal corresponding to torque delivered from the driving shaft when the rotating body rotates the predetermined degree based on the electric signal of the piezoelectric sensor and the control signal of the encoder unit; and
a power supply unit configured to supply power for driving the signal processor.

11. The torque measuring apparatus of claim 10, wherein the power supply unit comprises:
a power source;
a stator electrically connected to the stator and fixedly provided around an outside of the rotating body; and
a rotor mounted on the rotating body for integral rotation with the rotating body inside the stator, and electrically connected to the sensor unit for supplying electricity to the sensor unit.

12. The torque measuring apparatus of claim 11, wherein the encoder unit comprises:
an infrared light emitting portion disposed to the stator;
a first plate disposed to the infrared light emitting portion and having a plurality of first slits radially provided at angular intervals of a first predetermined angle, wherein infrared emitted from the infrared light emitting portion passes through the plurality of first slits;
a second plate fixedly mounted on the rotating body to face the first plate, and having a plurality of second slits radially provided at angular intervals of a second predetermined angle, the infrared passes through the plurality of first slits passing through the plurality of second slits;
an infrared light receiving portion receiving the infrared passed through the second plate; and
a circuit portion outputting the control signal when the infrared light receiving portion receives the infrared.

13. The torque measuring apparatus of claim 9, wherein the Bluetooth unit comprises:
a Bluetooth transmitter receiving the torque signal output from the sensor unit and transmitting the received torque signal through Bluetooth communication; and
a Bluetooth receiver receiving the torque signal transmitted from the Bluetooth transmitter.

14. A torque monitoring system, comprising:
a rotating body having one end fixedly connected to a driving shaft and a second end fixedly connected to a driven shaft;
a sensor unit outputting a torque signal corresponding to torque delivered from the driving shaft;
a Bluetooth unit including a Bluetooth transmitter receiving the torque signal output from the sensor unit and transmitting the received torque signal through Bluetooth communication, and a Bluetooth receiver receiving the torque signal transmitted from the Bluetooth transmitter; and
a monitoring unit connected to the Bluetooth receiver and monitoring the received torque signal.

15. The torque monitoring system of claim 14, wherein the rotating body, the sensor unit, and the Bluetooth transmitter are respectively provided as a plurality of rotating body, a plurality of sensor unit, and a plurality of Bluetooth units, and the respective elements are disposed to a plurality of torque measure locations of one object to be measured or respectively disposed to a plurality of torque measure locations of a plurality of objects to be measured.

16. The torque monitoring system of claim 14, wherein the sensor unit comprises:
a piezoelectric sensor disposed between the driving shaft and the rotating body or between the rotating body and the driven shaft, and configured to output an electric signal corresponding to the torque delivered from the driving shaft;
an encoder unit configured to output a corresponding control signal when the rotating body rotates a predetermined angle;
a signal processor configured to output a torque signal corresponding to torque delivered from the driving shaft when the rotating body rotates the predetermined angle based on the electric signal of the piezoelectric sensor and the control signal of the encoder unit; and
a power supply unit configured to supply a power for driving the signal processor.

17. A torque monitoring method, comprising:
measuring torque delivered from a driving shaft to a driven shaft at predetermined period and generating a corresponding electric signal;
generating a torque signal based on the electric signal;
wirelessly transmitting the torque signal through Bluetooth communication; and
monitoring the torque signal received through the Bluetooth communication.
